(19) United States
(12) Patent Application Publication
(10) Pub. No.: US 2026/0074776 A1
(43) Pub. Date: Mar. 12, 2026

(54) IN-ORBIT REAL-TIME TASK PROCESSING SYSTEM, METHOD, AND DEVICE BASED ON MULTI-SATELLITE COLLABORATIVE COMPUTING

(71) Applicant: ZHEJIANG LAB, Hangzhou (CN)

(72) Inventors: Ke Jiang, Hangzhou (CN); Chao Li, Hangzhou (CN); Zhi Wang, Hangzhou (CN); Ji He, Hangzhou (CN)

(21) Appl. No.: 19/083,509

(22) Filed: Mar. 19, 2025

Related U.S. Application Data
(63) Continuation of application No. PCT/CN2024/138290, filed on Dec. 10, 2024.

(30) Foreign Application Priority Data
Sep. 12, 2024 (CN) 202411279996.4

(51) Int. Cl. H04B 7/185; G06F 40/30; G06V 20/13

(52) U.S. Cl. CPC H04B 7/18513; G06F 40/30; G06V 20/13; G06V 2201/07

(57) ABSTRACT

Provided are an in-orbit real-time task processing system, method, and device based on multi-satellite collaborative computing. The system includes a ground center and a plurality of satellites. The ground center responds to instruction text of a user, determines a target satellite based on orbital trajectories of the satellites and the task location information, and sends the instruction text and the task location information to the target satellite. The target satellite collects a remote-sensing image in real-time, determines a data processing task corresponding to the instruction text through a remote-sensing large model, performs data processing on the remote-sensing image to obtain result data, and sends the result data to the ground center. The system realizes multi-satellite distributed computing and the forwarding of information to any location through the satellite interconnection network, and can obtain real-time remote data, which improves the convenience and efficiency of satellite remote sensing image applications.

### CROSS REFERENCE TO RELATED APPLICATIONS

The present application is a Continuation Application of PCT Application No. PCT/CN2024/138290 filed on Dec. 10, 2024, which claims the benefit of Chinese Patent Application No. 202411279996.4 filed on Sep. 12, 2024. All the above are hereby incorporated by reference in their entirety.

### TECHNICAL FIELD

The present disclosure relates to the technical field of computers, and in particular, to an in-orbit real-time task processing system, method, and device based on multi-satellite collaborative computing.

### BACKGROUND

In current technology, satellites in orbit directly transmit raw remote sensing images to the ground center, which not only transmits a large amount of data, but also has limited transmission efficiency. However, if the satellite processes the captured remote sensing images while in orbit and only downlinks the streamlined information, the data transmission burden can be significantly reduced and the efficiency can be improved. Combined with multi-satellite interconnection and collaborative computing technology, this method improves the utilization efficiency of communication links and realizes in-orbit real-time analysis, thus bringing the dual advantages of rapid response and efficient resource utilization.

Based on this, the present disclosure provides an in-orbit real-time task processing system, method, and device based on multi-satellite collaborative computing.

### SUMMARY

The present disclosure provides an in-orbit real-time task processing system, method, and device based on multi-satellite collaborative computing, to partially solve the foregoing problems in the prior art.

The present disclosure adopts the following technical solutions:

The present disclosure provides an in-orbit real-time task processing system based on multi-satellite collaborative computing, where the in-orbit real-time task processing system includes a ground center and a plurality of satellites;
the ground center responds to instruction text of a user and determines task location information in the instruction text; determines a target satellite from the satellites based on orbital trajectories of the satellites and the task location information; and sends the instruction text and the task location information to the target satellite; and
the target satellite collects a remote-sensing image based on the task location information; inputs the remote-sensing image and the instruction text into a pre-configured remote-sensing large model, determines a data processing task corresponding to the instruction text, and performs data processing on the remote-sensing image based on the data processing task to obtain result data output by the remote-sensing large model; and sends the result data to the ground center.

Optionally, the target satellite inputs the remote-sensing image and the instruction text into the remote-sensing large model, and performs semantic analysis on the instruction text through the remote-sensing large model to determine an observation target corresponding to the instruction text; determines the data processing task corresponding to the instruction text as a target extraction task for the observation target; and performs target extraction on the remote-sensing image based on the observation target to obtain a target image output by the remote-sensing large model; and
determines the result data based on the target image.

Optionally, the observation target in the remote-sensing image is determined through the remote-sensing large model, and the target image is determined based on a corresponding image region of the observation target in the remote-sensing image.

Optionally, the target satellite performs image analysis on the observation target in the target image by using the remote-sensing large model based on the instruction text, and generates result text corresponding to the instruction text; and
determines the result data based on the result text.

Optionally, each of the satellites is equipped with a satellite-borne router; and
the ground center determines, from the satellites based on the orbital trajectories of the satellites and the task location information, a satellite that communicates with the ground center as a return satellite and a satellite between the target satellite and the return satellite as a transfer satellite; and determines an inter-satellite communication path among the target satellite, the transfer satellite, and the return satellite.

Optionally, the ground center uploads the instruction text and the task location information to the return satellite;
the return satellite sends the instruction text and the task location information to the transfer satellite through the inter-satellite communication path; and
the transfer satellite sends the instruction text and the task location information to the target satellite through the inter-satellite communication path.

Optionally, the target satellite sends the result data to the transfer satellite through the inter-satellite communication path;
the transfer satellite sends the result data to the return satellite through the inter-satellite communication path; and
the return satellite transmits the result data to the ground center.

Optionally, the target satellite includes a plurality of computing boards; and
the target satellite determines a computing board for performing the data processing task as a target board; monitors performance parameters of the computing boards; and re-determines a target board from various computing boards excluding the target board when determining, based on a performance parameter of the target board, that performance of the target board is abnormal.

The present disclosure provides an in-orbit real-time task processing method based on multi-satellite collaborative computing, where the in-orbit real-time task processing method is applied to a ground center of an in-orbit real-time task processing system based on multi-satellite collaborative computing, the in-orbit real-time task processing system includes the ground center and a plurality of satellites, and the in-orbit real-time task processing method includes:
responding to instruction text of a user, and determining task location information in the instruction text;
determining a target satellite from the satellites based on orbital trajectories of the satellites and the task location information; and
sending the instruction text and the task location information to the target satellite, such that the target satellite collects a remote-sensing image based on the task location information, inputs the remote-sensing image and the instruction text into a pre-configured remote-sensing large model, determines a data processing task corresponding to the instruction text, performs data processing on the remote-sensing image based on the data processing task to obtain result data output by the remote-sensing large model, and sends the result data to the ground center.

The present disclosure provides an in-orbit real-time task processing method based on multi-satellite collaborative computing, where the in-orbit real-time task processing method is applied to a target satellite of an in-orbit real-time task processing system based on multi-satellite collaborative computing, the in-orbit real-time task processing system includes a ground center and a plurality of satellites, the target satellite is determined by the ground center from the satellites based on task location information in instruction text of a user and orbital trajectories of the satellites, and the in-orbit real-time task processing method includes:
receiving the instruction text and the task location information that are sent by the ground center;
collecting a remote-sensing image based on the task location information;
inputting the remote-sensing image and the instruction text into a pre-configured remote-sensing large model, determining a data processing task corresponding to the instruction text, and performing data processing on the remote-sensing image based on the data processing task to obtain result data output by the remote-sensing large model; and
sending the result data to the ground center.

The present disclosure provides an in-orbit real-time task processing device based on multi-satellite collaborative computing, where the in-orbit real-time task processing device is applied to a ground center of an in-orbit real-time task processing system based on multi-satellite collaborative computing, the in-orbit real-time task processing system includes the ground center and a plurality of satellites, and the in-orbit real-time task processing device includes:
a task location determining module configured to respond to instruction text of a user, and determine task location information in the instruction text;
a target satellite determining module configured to determine a target satellite from the satellites based on orbital trajectories of the satellites and the task location information; and
a first transmission module configured to send the instruction text and the task location information to the target satellite, such that the target satellite collects a remote-sensing image based on the task location information, inputs the remote-sensing image and the instruction text into a pre-configured remote-sensing large model, determines a data processing task corresponding to the instruction text, performs data processing on the remote-sensing image based on the data processing task to obtain result data output by the remote-sensing large model, and sends the result data to the ground center.

The present disclosure provides an in-orbit real-time task processing device based on multi-satellite collaborative computing, where the in-orbit real-time task processing device is applied to a target satellite of an in-orbit real-time task processing system based on multi-satellite collaborative computing, the in-orbit real-time task processing system includes a ground center and a plurality of satellites, the target satellite is a satellite that is used for image collection and determined by the ground center from the satellites based on task location information in instruction text of a user and orbital trajectories of the satellites, and the in-orbit real-time task processing device includes:
a receiving module configured to receive the instruction text and the task location information that are sent by the ground center;
a collection module configured to collect a remote-sensing image based on the task location information;
a data processing module configured to input the remote-sensing image and the instruction text into a pre-configured remote-sensing large model, determine a data processing task corresponding to the instruction text, and perform data processing on the remote-sensing image based on the data processing task to obtain result data output by the remote-sensing large model; and
a second transmission module configured to send the result data to the ground center.

At least one of the foregoing technical solutions adopted in the present disclosure can achieve the following beneficial effects:

An in-orbit real-time task processing system based on multi-satellite collaborative computing provided in the present disclosure includes a ground center and a plurality of satellites. The ground center responds to instruction text of a user, determines task location information in the instruction text, determines a target satellite from the satellites based on orbital trajectories of the satellites and the task location information, and sends the instruction text and the task location information to the target satellite. The target satellite collects a remote-sensing image based on the task location information, inputs the remote-sensing image and the instruction text into a remote-sensing large model, determines a data processing task corresponding to the instruction text, performs data processing on the remote-sensing image based on the data processing task to obtain result data, and sends the result data to the ground center. Through the system, the ground center can directly send the instruction text that is of the user and in a natural language form to the target satellite, such that the target satellite can perform the data processing on the remote-sensing image collected based on the instruction text and the user does not need to input a professional task instruction, thereby reducing an operation threshold of an in-orbit data processing task.

### BRIEF DESCRIPTION OF THE DRAWINGS

The accompanying drawings described herein are provided for further understanding of the present disclosure, and constitute a part of the present disclosure. The exemplary embodiments of the present disclosure and illustrations thereof are intended to explain the present disclosure, but do not constitute inappropriate limitations on the present disclosure. In the accompanying drawings:

FIG. 1 is a schematic diagram of an execution process of an in-orbit real-time task processing system based on multi-satellite collaborative computing according to the present disclosure;

FIG. 2 shows a four-star collaborative in-orbit processing scenario according to an embodiment of the present disclosure;

FIG. 3 is a schematic diagram of composition of a satellite payload according to an embodiment of the present disclosure;

FIG. 4 is a schematic flowchart of an in-orbit real-time task processing method based on multi-satellite collaborative computing according to the present disclosure;

FIG. 5 is a schematic flowchart of another in-orbit real-time task processing method based on multi-satellite collaborative computing according to the present disclosure;

FIG. 6 is a schematic diagram of an in-orbit real-time task processing device based on multi-satellite collaborative computing that corresponds to FIG. 4 according to the present disclosure; and

FIG. 7 is a schematic diagram of another in-orbit real-time task processing device based on multi-satellite collaborative computing that corresponds to FIG. 5 according to the present disclosure.

### DETAILED DESCRIPTION

To make the objectives, technical solutions, and advantages of the present disclosure clearer, the technical solutions in the present disclosure are clearly and completely described below with reference to specific embodiments and corresponding accompanying drawings of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

The technical solutions provided in the embodiments of the present disclosure are described in detail below with reference to the accompanying drawings.

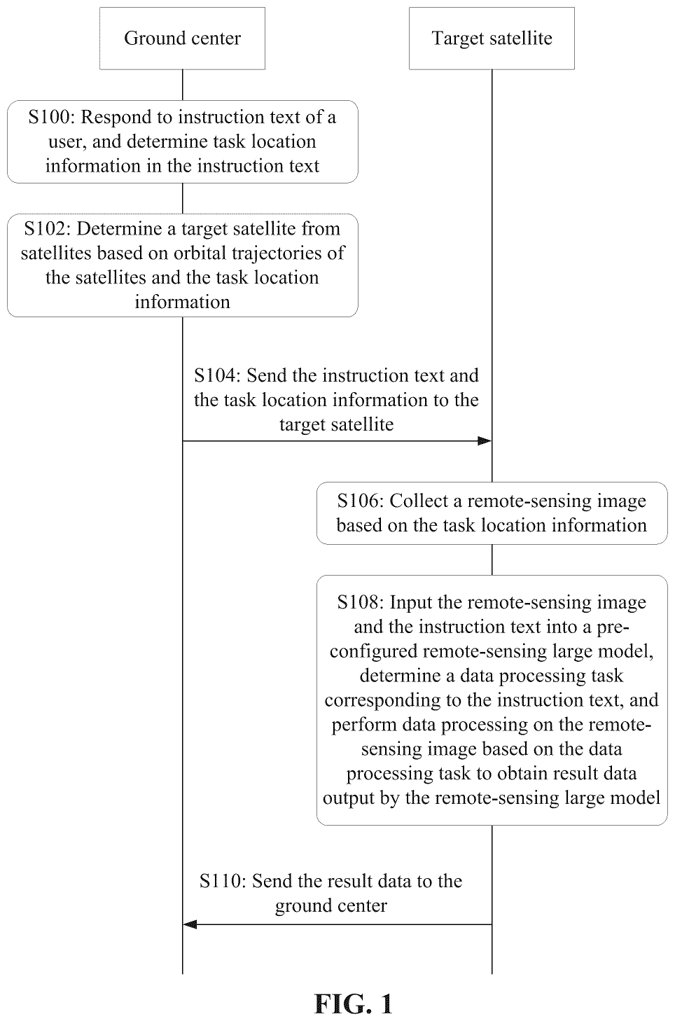

FIG. 1 is a schematic diagram of an execution process of an in-orbit real-time task processing system based on multi-satellite collaborative computing according to the present disclosure. The system includes a ground center and a plurality of satellites. Specifically, the following steps are included:

S100: The ground center responds to instruction text of a user, and determines task location information in the instruction text.

In the in-orbit real-time task processing system based on multi-satellite collaborative computing provided in the present disclosure, the ground center is deployed in a ground station, and each satellite is in an in-orbit running state. In the present disclosure, a specific type of the satellite in the system is not limited, and may be any type of satellite, such as a remote-sensing satellite, a meteorological satellite, or a navigation satellite. The satellites in the system may include one or more types of satellites.

The system can perform an in-orbit data processing task on a remote-sensing image based on the instruction text that is in a natural language form and sent by the user.

Usually, in a data processing task of a remote-sensing image of the satellite, it is necessary to send an instruction for determining task location information to the satellite, such that the satellite can collect the remote-sensing image based on the task location information. In the present disclosure, the user sends the instruction text. Therefore, the ground center extracts information from the instruction text to determine the task location information in the instruction text.

The instruction text is adopted, which can reduce an operation difficulty of the user and make an input of the user more flexible. There is no fixed format limitation on the instruction text in the present disclosure, provided that the instruction text semantically includes the task location information that characterizes a collection location of the remote-sensing image and a data processing operation performed on the collected remote-sensing image.

A form of the task location information in the instruction text may be a location name, latitude and longitude, or the like. The data processing task of the collected remote-sensing image may be an image processing task such as target extraction, denoising, radiometric correction, or geometric correction, may be a text inference task performed on the remote-sensing image through a remote-sensing large model, or the like.

S102: The ground center determines a target satellite from the satellites based on orbital trajectories of the satellites and the task location information.

Because the satellite is in motion, only a satellite within a signal reception range of the ground station can establish a communication link with the ground center. The ground center can monitor the orbital trajectories of the satellites. Based on a orbital trajectory of each in-orbit satellite at a current time point, the ground center performs task planning, and determines a satellite that performs image collection in the satellites as the target satellite.

There are two task planning methods in the present disclosure: task planning for a single-satellite execution task and task planning for a multi-satellite collaborative execution task. Based on an actual task requirement, the ground center can determine one satellite to execute a task alone or determine a plurality of satellites to execute the task in a collaborative manner.

Different task planning methods have different signal transmission methods. For ease of description, the following first provides description based on the task planning method for the single-satellite execution task. After relevant content of the task planning method is described, an embodiment of the multi-satellite collaborative task planning method is provided.

S104: The ground center sends the instruction text and the task location information to the target satellite.

In the task planning method for the single-satellite execution task, the target satellite is a satellite within the signal reception range of the ground station at the current time point. The ground center establishes a communication link with the target satellite, and then sends the instruction text and the task location information to the target satellite.

S106: The target satellite collects the remote-sensing image based on the task location information.

A task location corresponding to the task location information contained in the instruction text may be any location, and the target satellite is the satellite within the signal reception range of the ground station at the current time point. Therefore, there may be two situations when the task location corresponds to the target satellite, namely, the task location is within or not within an observation range of the target satellite.

In the task planning method for the single-satellite execution task, if the target satellite determines based on the task location information that the task location corresponding to the task location information is within the observation range of the target satellite, the target satellite completes the image collection for the task location in a current trajectory position to obtain the remote-sensing image.

If the target satellite determines based on the task location information that the task location corresponding to the task location information is not within the observation range of the target satellite, after receiving the instruction text and the task location position, the target satellite continues running along a trajectory of the target satellite until the task location is within the observation range of the target satellite, and performs the image collection for the task location to obtain the remote-sensing image.

S108: The target satellite inputs the remote-sensing image and the instruction text into the pre-configured remote-sensing large model, determines a data processing task corresponding to the instruction text, and performs data processing on the remote-sensing image based on the data processing task to obtain result data output by the remote-sensing large model.

S110: The target satellite sends the result data to the ground center.

Because the instruction in the present disclosure is the instruction text in the natural language form, the target satellite needs to determine a corresponding data processing operation based on the instruction text. This process can be completed through the remote-sensing large model, and each satellite in the system is equipped with the remote-sensing large model.

The remote-sensing large model in the present disclosure is a pre-configured and trained remote-sensing image processing model. The remote-sensing large model can perform the data processing on the input remote-sensing image based on a remote-sensing image input and a text prompt to generate a processed image corresponding to the text prompt or result text corresponding to the text prompt as the result data. In a practical application, whether the result data is processed image data or text data needs to be determined based on the instruction text input by the user. The instruction text input by the user is the text prompt input into the remote-sensing large model.

The target satellite inputs the remote-sensing image and the instruction text into the remote-sensing large model, determines the data processing task corresponding to the instruction text, and performs the data processing on the remote-sensing image based on the data processing task to obtain the result data output by the remote-sensing large model.

The data processing task in the present disclosure needs to be determined based on specific content of the instruction text, and may be the image processing task such as the target extraction, the denoising, the radiometric correction, or the geometric correction, or may be the text inference task performed on the remote-sensing image through the remote-sensing large model.

Because the instruction text is a natural language instruction, a running mode of the in-orbit real-time task processing system based on multi-satellite collaborative computing in the present disclosure is a question answering mode. The instruction text of the user is a question, and the result data returned by the system is an answer. Through the system, the user can send a remote-sensing image data processing instruction through natural language text, reducing operation complexity of the user.

Based on the system shown in FIG. 1, the ground center can directly send the instruction text that is of the user and in the natural language form to the target satellite, such that the target satellite can perform the data processing on the remote-sensing image collected based on the instruction text and the user does not need to input a professional task instruction, thereby reducing an operation threshold of the in-orbit data processing task.

The following describes the multi-satellite collaborative task planning method in the above step S102.

When the ground center adopts the multi-satellite collaborative task planning method, among the satellites, the satellite that performs the image collection is determined as the target satellite, a satellite that communicates with the ground station is determined as a return satellite, and a satellite between the target satellite and the return satellite is determined as a transfer satellite.

The return satellite in this embodiment is a satellite within the signal reception range of the ground station at the current time point, and the target satellite in this embodiment is a satellite whose observation range includes the task location. The transfer satellite in this embodiment establishes an inter-satellite communication path together with the target satellite and the return satellite during communication between the target satellite and the return satellite. Depending on an actual task situation, there may be one transfer satellite, a plurality of transfer satellites, or no transfer satellite in this embodiment. A specific quantity of transfer satellites is related to a distance between the return satellite and the target satellite.

Particularly, when there is no transfer satellite, only the return satellite and the target satellite are instructed to participate in the data processing task. Because both the return satellite and the transfer satellite are used as data transmission intermediaries of the target satellite in a data transmission process, it can be considered that the return satellite also serves as the transfer satellite.

In the multi-satellite collaborative task planning method, different satellites establish an inter-satellite communication path through a satellite-borne router, and then communicate with each other through an Ethernet.

Specifically, after the ground center determines the target satellite, a communication path can be determined based on an inter-satellite topology and communication status. The inter-satellite communication path among the return satellite, the transfer satellite, and the target satellite is established through satellite-borne routers of the target satellite, the return satellite, and the transfer satellite.

After the inter-satellite communication path is determined, in the above step S104, the ground center can upload the instruction text and the task location information to the return satellite, the return satellite then sends the instruction text and the task location information to the transfer satellite through the inter-satellite communication path, and the transfer satellite forwards the instruction text and the task location information to the target satellite.

Because the return satellite is the satellite within the signal reception range of the ground station at the current time point, the ground center can perform satellite-ground communication with the return satellite to upload the instruction text and the task location information to the return satellite.

The target satellite is the satellite whose observation range at a current location includes the task location. After receiving the instruction text and the task location information, the target satellite collects the remote-sensing image. In addition, the data processing is performed on the remote-sensing image according to the method in the above step S108 to obtain the result data.

Then, in the above step S110, the target satellite sends the result data to the transfer satellite through the inter-satellite communication path, and the transfer satellite then sends the result data to the return satellite, such that the return satellite transmits the result data to the ground center.

In the task planning method for the single-satellite execution task mentioned in the step S102, when the task location is not within the observation range of the target satellite, the target satellite needs to continue running for a period of time before collecting the remote-sensing image. During the running of the target satellite, time for the data processing task increases, resulting in a delay in receiving the result data by the ground center of the ground station.

In this embodiment, there is no need to wait for the target satellite to continue running. The ground center determines, from the satellites based on a orbital trajectory of each in-orbit satellite, a plurality of satellites to jointly complete image collection and data processing tasks corresponding to the instruction text. Through the inter-satellite communication path, the instruction text and the task location information are transmitted on the inter-satellite communication path, which improves transmission efficiency and enables the result data to be transmitted to the ground center earlier, thereby achieving more significant real-time performance.

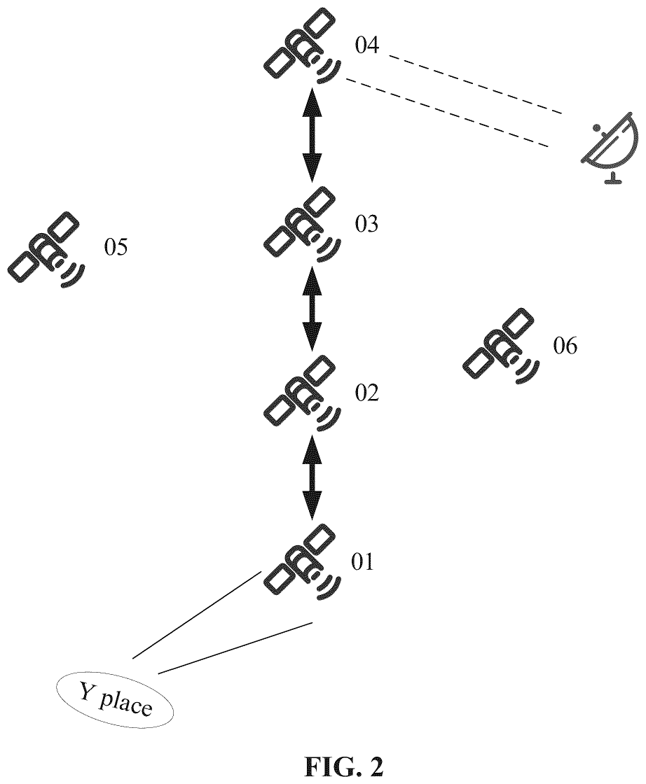

The multi-satellite collaborative task planning method in the present disclosure is described below with reference to FIG. 2. FIG. 2 shows a four-star collaborative in-orbit processing scenario according to an embodiment of the present disclosure.

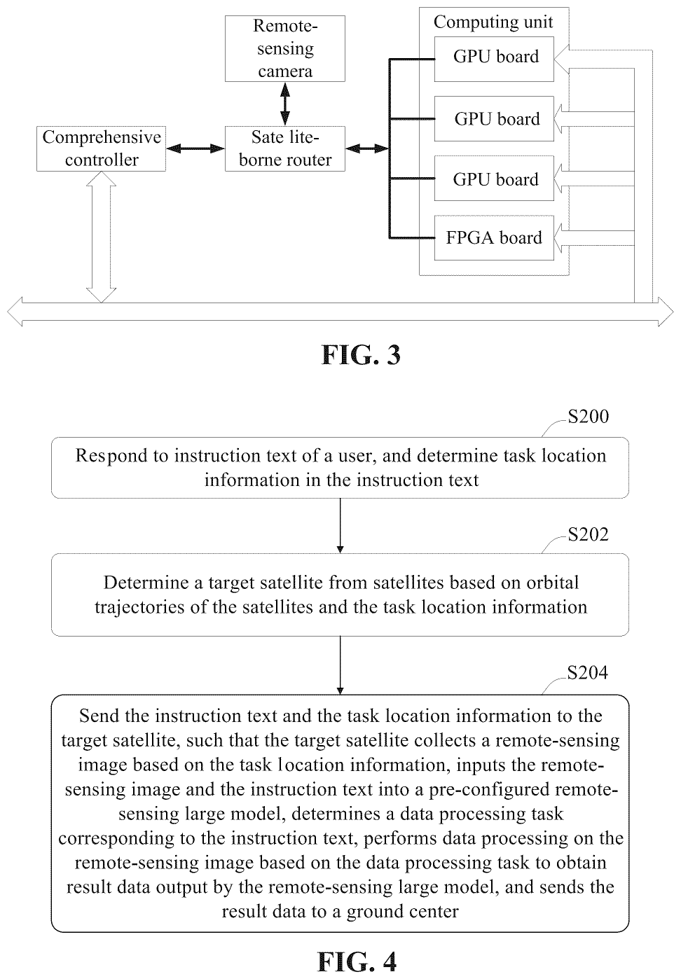

In FIG. 2, dual dashed lines represent a satellite-ground communication path, a double-headed arrow represents the inter-satellite communication path, and an ellipse represents a task location “Y place”. The satellite within the signal reception range of the ground station is a satellite 04, which is the return satellite. The satellite whose observation range includes the task location is a satellite 01, which is the target satellite for collecting the remote-sensing image. Satellites 02 and 03 are transfer satellites, and the inter-satellite communication path is as follows: the satellite 01-the satellite 02-the satellite 03-the satellite 04. Satellites 05 and 06 in FIG. 3 do not participate in establishing the inter-satellite communication path.

As shown in FIG. 2, the ground center determines the inter-satellite communication path among the satellite 01 to the satellite 04 to facilitate subsequent data transmission.

When the satellite 04 flies over the signal reception range of the ground station, the ground center uploads instruction text and task location information to the satellite 04. After receiving the instruction text and the task location information, the satellite 04 forwards a task instruction to the satellite 01 in a transmission order of the satellite 04→the satellite 03→the satellite 02→the satellite 01 through the inter-satellite communication path. After receiving the instruction text and the task location information, the satellite 01 collects a remote-sensing image of the Y place.

Then, the target satellite inputs the instruction text and the collected remote-sensing image into the remote-sensing large model, and performs data processing on the remote-sensing image to obtain result data. The result data is forwarded to the satellite 04 in a transmission order of the satellite 01→the satellite 02→the satellite 03→the satellite 04 through the inter-satellite communication path, and the satellite 04 transmits the result data to the ground center.

In one or more embodiments of the present disclosure, in order to enhance an anti-interference capability of the in-orbit real-time task processing system based on multi-satellite collaborative computing in the present disclosure to enable the system to run normally even under an abnormal condition, the system can support the task planning for a plurality of times.

Specifically, after the inter-satellite communication path is determined in the above embodiments, when the ground center detects that an abnormal signal from a satellite in the communication path affects the data transmission, the task planning is carried out again based on the orbital trajectories of the satellites to re-determine the target satellite, the transfer satellite, and the return satellite. The data processing task is continuously completed through a re-determined target satellite, transfer satellite, and return satellite.

Generally, because the satellite is in motion, time for a satellite to be within the signal reception range of the ground station is limited. During data transmission between the return satellite and the ground center, the return satellite may gradually fly out of the signal reception range of the ground station. In this case, the ground center can perform the task planning based on the orbital trajectories of the satellites, and re-determine the target satellite, the transfer satellite, and the return satellite to continuously complete the data processing task.

In one or more embodiments of the present disclosure, the result data in the above step S100 may be image data. The following takes target recognition as an example to describe this embodiment.

The target satellite inputs the remote-sensing image and the instruction text into the remote-sensing large model, performs semantic analysis on the instruction text through the remote-sensing large model to determine an observation target corresponding to the instruction text, and then determines the data processing task corresponding to the instruction text as a target extraction task for the observation target; performs target extraction on the remote-sensing image based on the observation target to obtain a target image output by the remote-sensing large model; and determines the result data based on the target image.

The remote-sensing large model in this embodiment may include a semantic analysis layer and a task processing layer. The task processing layer includes operation sub-layers corresponding to various data processing tasks, such as a target extraction sub-layer, a noise reduction sub-layer, and a text generation sub-layer.

Specifically, the target satellite first inputs the instruction text into the semantic analysis layer of the remote-sensing large model, performs the semantic analysis on the instruction text, determines the observation target corresponding to the instruction text, and determines the data processing task as the target extraction task. Then, the target satellite inputs the remote-sensing image and the observation target determined by the semantic analysis layer into the target extraction sub-layer of the task processing layer, and performs the data processing on the remote-sensing image to obtain the target image output by the remote-sensing large model.

The above target extraction task may be represented in various forms. For example, a remote-sensing image containing the observation target may be selected from a plurality of remote-sensing images as the target image, or an image region containing the observation target may be extracted from one remote-sensing image.

In an embodiment, when the target satellite extracts the image region containing the observation target from the remote-sensing image based on the instruction text through the remote-sensing large model, the target satellite determines the observation target in the remote sensing-image through the target extraction sub-layer of the remote-sensing large model, and determines the target image based on the corresponding image region of the observation target in the remote-sensing image.

The target image obtained in this embodiment only includes image information of the observation target, which further reduces an amount of data transmitted downwards, reduces downward data transmission time, and improves real-time performance of the data processing task, compared with an original remote-sensing image.

In one or more embodiments of the present disclosure, the result data in the above step S100 may be text data.

Based on the target image obtained in the above target recognition, the target satellite performs image analysis on the observation target in the target image based on the instruction text through the remote-sensing large model, generates result text corresponding to the instruction text, and determines the result data based on the result text.

In this embodiment, the target satellite can input the target image and the instruction text into the text generation sub-layer of the remote-sensing large model, perform the image analysis on the observation target in the target image, and generate the result text.

Alternatively, in another embodiment, the target satellite may not perform the target recognition, but performs image analysis on the remote-sensing image based on the instruction text through the remote-sensing large model, generates result text corresponding to the instruction text, and determines the result data based on the result text.

Compared with the image data, the text data has a smaller data volume. The target satellite performs the data processing on the remote-sensing image to obtain the text data and then transmits the text data downwards, which can greatly reduce data transmission time.

In one or more embodiments of the present disclosure, in order to obtain a more accurate data processing result, the target satellite may preprocess the remote-sensing image before performing the data processing on the remote-sensing image. The preprocessing includes the denoising, the radiometric correction, the geometric correction, and the like.

In order to further improve accuracy of the data processing and enable the system to accurately adapt to demands for different data processing tasks, the target satellite can determine different data processing levels based on different fineness of the data processing. The different data processing levels correspond to different data processing operations.

The target satellite analyzes the instruction text, determines a data processing level that matches the instruction text among preset data processing levels, and performs the data processing on the remote-sensing image according to a data processing operation of the matching data processing level.

For example, in a classification method, the remote-sensing image is divided into five levels from a level 0 to a level 4. From the level 0 to the level 4, a fineness degree of processing the remote-sensing image and geometric precision of the remote-sensing image gradually increase. Therefore, the target satellite can preset data processing operations corresponding to these four levels, determine a matching level of the instruction text based on the task instruction, and perform, according to a data processing operation corresponding to the matching level, the data processing on the remote-sensing image collected by the target satellite.

In one or more embodiments of the present disclosure, in order to further reduce the amount of data transmitted downwards and to further reduce an amount of data transmitted to the ground center, the target satellite can compress the result data through a compression algorithm, and then send the compressed result data to the ground center. The present disclosure does not limit a specific compression algorithm used in a compression process, and any existing compression algorithm such as JPEG2000 or H.264 can be selected as required.

In one or more embodiments of the present disclosure, the target satellite can use a Docker container technology to dynamically allocate its computing resource to improve data processing efficiency, thereby increasing computing resource utilization and improving computing efficiency.

In order to further improve the real-time performance of the data processing task, in the multi-satellite collaborative task planning method, the target satellite can use the Docker container technology to divide the data processing task corresponding to the remote-sensing image into a plurality of subtasks, and allocate the subtasks to the transfer satellite or the return satellite. Thus, the target satellite, the transfer satellite, and the return satellite can process their corresponding subtasks in parallel, thereby improving the data processing efficiency, and achieving real-time data processing.

In addition, in order to improve security of the data transmission, after determining the result data, the target satellite can encrypt the result data through an encryption algorithm and send encrypted result data to the ground center.

In one or more embodiments of the present disclosure, in order to obtain a higher-quality remote-sensing image through the target satellite, the ground center can determine a lateral-swing angle of a remote-sensing camera of the target satellite based on the task location information and a orbital trajectory of the target satellite before the above step S104.

Then, the ground center sends the instruction text, the task location information, and the lateral-swing angle to the target satellite, such that the target satellite adjusts its remote-sensing camera to the lateral-swing angle to collect the remote-sensing image.

It should be noted that if the task planning method for the single-satellite execution task is adopted, the ground center directly sends the instruction text, the task location information, and the lateral-swing angle to the target satellite through the satellite-ground communication path. If the multi-satellite collaborative task planning method is adopted, the ground center first sends the instruction text, the task location information, and the lateral-swing angle to the return satellite through the satellite-ground communication path, and then the return satellite forwards the instruction text, the task location information, and the lateral-swing angle to the target satellite via the transfer satellite through the inter-satellite communication path.

In one or more embodiments of the present disclosure, in order to increase fault tolerance of an in-orbit processing system of the remote-sensing image in the present disclosure, each satellite in the system may include a plurality of computing boards.

The present disclosure does not limit a specific type and quantity of computing boards included in a computing unit, and the computing unit may contain at least one computing board of one or more types. A type of the computing board may be a Graphics Processing Unit (GPU), a Field Programmable Gate Arrays (FPGA), or the like.

Therefore, in a process of performing the data processing on the remote-sensing image by the target satellite, the target satellite determines a computing board for performing the data processing task as a target board. In addition, performance parameters of the computing boards are continuously monitored. When it is determined based on a performance parameter of the target board that performance of the target bard is abnormal, a target board is re-determined from various computing boards excluding the target board to continue to execute the data processing task.

Based on the above embodiments, the present disclosure provides a schematic diagram of composition of a satellite payload. FIG. 3 is a schematic diagram of composition of a satellite payload according to an embodiment of the present disclosure.

In FIG. 3, the satellite payload includes a comprehensive controller, the computing unit, the satellite-borne router, and the remote-sensing camera. The computing unit consists of three GPU boards and one FPGA board. A dark arrow is used to indicate an Ethernet connection, and a light arrow is used to indicate a bus connection.

Because the satellite consumes a large amount of energy during running, keeping the payload on the satellite powered on will continuously consume energy. In order to reduce an unnecessary energy consumption, in one or more embodiments of the present disclosure, each satellite can turn on a corresponding payload after receiving the instruction text.

Specifically, after receiving the instruction text and the task location information that are sent by the ground center, the target satellite is powered on through the comprehensive controller, the computing unit, and the remote-sensing camera.

The present disclosure further provides an in-orbit real-time task processing method based on multi-satellite collaborative computing that corresponds to the system in FIG. 1.

FIG. 4 is a schematic flowchart of an in-orbit real-time task processing method based on multi-satellite collaborative computing. The method is applied to a ground center of an in-orbit real-time task processing system based on multi-satellite collaborative computing, and the system includes the ground center and a plurality of satellites.

As shown in FIG. 4, the method includes the following steps:

S200: Respond to instruction text of a user, and determine task location information in the instruction text.

S202: Determine a target satellite from the satellites based on orbital trajectories of the satellites and the task location information.

S204: Send the instruction text and the task location information to the target satellite, such that the target satellite collects a remote-sensing image based on the task location information, inputs the remote-sensing image and the instruction text into a pre-configured remote-sensing large model, determines a data processing task corresponding to the instruction text, performs data processing on the remote-sensing image based on the data processing task to obtain result data output by the remote-sensing large model, and sends the result data to the ground center.

Optionally, each of the satellites is equipped with a satellite-borne router.

Before sending the instruction text and the task location information to the target satellite, the method further includes:
determining, from the satellites based on the orbital trajectories of the satellites and the task location information, a satellite that communicates with the ground center in the satellites as a return satellite and a satellite between the target satellite and the return satellite as a transfer satellite; and
determining an inter-satellite communication path among the target satellite, the transfer satellite, and the return satellite.

Optionally, the sending the instruction text and the task location information to the target satellite specifically includes:
uploading the instruction text and the task location information to the return satellite, such that the return satellite sends the instruction text and the task location information to the transfer satellite through the inter-satellite communication path, and then the transfer satellite forwards the instruction text and the task location information to the target satellite through the inter-satellite communication path.

For specific content of the steps S200 to S204 corresponding to FIG. 4, reference may be made to the description of the corresponding content in FIG. 1, and details are not described herein again.

The present disclosure further provides another in-orbit real-time task processing method based on multi-satellite collaborative computing.

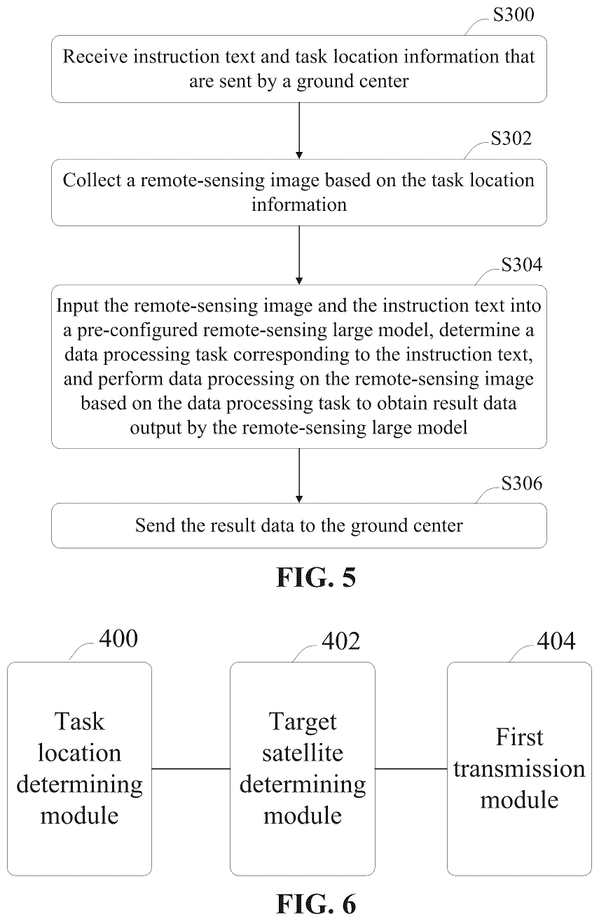

FIG. 5 is a schematic flowchart of still another in-orbit real-time task processing method based on multi-satellite collaborative computing. The method is applied to a target satellite of an in-orbit real-time task processing system based on multi-satellite collaborative computing, the system includes a ground center and a plurality of satellites, and the target satellite is determined by the ground center from the satellites based on task location information in instruction text of a user and orbital trajectories of the satellites.

As shown in FIG. 5, the method includes the following steps.

S300: Receive the instruction text and the task location information that are sent by the ground center.

S302: Collect a remote-sensing image based on the task location information.

S304: Input the remote-sensing image and the instruction text into a pre-configured remote-sensing large model, determine a data processing task corresponding to the instruction text, and perform data processing on the remote-sensing image based on the data processing task to obtain result data output by the remote-sensing large model.

Optionally, the inputting the remote-sensing image and the instruction text into a pre-configured remote-sensing large model, determining a data processing task corresponding to the instruction text, and performing data processing on the remote-sensing image based on the data processing task to obtain result data output by the remote-sensing large model specifically includes:
inputting the remote-sensing image and the instruction text into the pre-configured remote-sensing large model, and performing semantic analysis on the instruction text through the remote-sensing large model to determine an observation target corresponding to the instruction text; determining the data processing task corresponding to the instruction text as a target extraction task for the observation target; and performing target extraction on the remote-sensing image based on the observation target to obtain a target image output by the remote-sensing large model; and
determining the result data based on the target image.

Optionally, the performing target extraction on the remote-sensing image based on the observation target to obtain a target image output by the remote-sensing large model specifically includes:
determining the observation target in the remote-sensing image through the remote-sensing large model, and determining the target image based on a corresponding image region of the observation target in the remote-sensing image.

Optionally, the determining the result data based on the target image specifically includes:
performing image analysis on the observation target in the target image by using the remote-sensing large model based on the instruction text, and generating result text corresponding to the instruction text; and
determining the result data based on the result text.

S306: Send the result data to the ground center.

Optionally, each of the satellites is equipped with a satellite-borne router.

Optionally, the sending the result data to the ground center specifically includes:
sending the result data to a transfer satellite through an inter-satellite communication path, such that the transfer satellite sends the result data to the return satellite through the inter-satellite communication path, and then the return satellite transmits the result data to the ground center, where the inter-satellite communication path is determined by the ground center based on the orbital trajectories of the satellites and the task location information.

Optionally, the target satellite includes a plurality of computing boards; and
the method further includes:
determining a computing board for performing the data processing task as a target board; and
monitoring performance parameters of the computing boards; and when it is determined based on a performance parameter of the target board that performance of the target bard is abnormal, re-determining a target board from various computing boards excluding the target board.

For specific content of the steps S300 to S306 corresponding to FIG. 5, reference may be made to the description of the corresponding content in FIG. 1, and details are not described herein again.

Based on the same principle, the present disclosure further provides an in-orbit real-time task processing device based on multi-satellite collaborative computing.

FIG. 6 is a schematic diagram of an in-orbit real-time task processing device based on multi-satellite collaborative computing that corresponds to FIG. 4 according to the present disclosure. The device is applied to a ground center of an in-orbit real-time task processing system based on multi-satellite collaborative computing, and the system includes the ground center and a plurality of satellites. As shown in FIG. 6, the device includes:
a task location determining module 400 configured to respond to instruction text of a user, and determine task location information in the instruction text;
a target satellite determining module 402 configured to determine a target satellite from the satellites based on orbital trajectories of the satellites and the task location information; and
a first transmission module 404 configured to send the instruction text and the task location information to the target satellite, such that the target satellite collects a remote-sensing image based on the task location information, inputs the remote-sensing image and the instruction text into a pre-configured remote-sensing large model, determines a data processing task corresponding to the instruction text, performs data processing on the remote-sensing image based on the data processing task to obtain result data output by the remote-sensing large model, and sends the result data to the ground center.

Optionally, each of the satellites is equipped with a satellite-borne router, and the first transmission module 404 is specifically configured to: determine, from the satellites based on the orbital trajectories of the satellites and the task location information, a satellite that communicates with the ground center as a return satellite and a satellite between the target satellite and the return satellite as a transfer satellite; determine a communication path among the target satellite, the transfer satellite, and the return satellite, and generate an inter-satellite link establishment instruction based on the communication path; upload the inter-satellite link establishment instruction to the return satellite; and send the inter-satellite link establishment instruction to the transfer satellite and the target satellite through the return satellite.

Optionally, the first transmission module 404 is specifically configured to upload the instruction text and the task location information to the return satellite, such that the return satellite sends the instruction text and the task location information to the transfer satellite through the inter-satellite communication path, and then the transfer satellite forwards the instruction text and the task location information to the target satellite through the inter-satellite communication path.

In this embodiment of the present disclosure, the task location determining module 400, the target satellite determining module 402, and the first transmission module 404 each may be one or more processors or chips that each have a communication interface, can realize a communication protocol, and may further include a memory, a related interface and system transmission bus, and the like if necessary. The processor or chip executes program-related code to realize a corresponding function. In an alternative solution, the task location determining module 400, the target satellite determining module 402, and the first transmission module 404 share an integrated chip or share devices such as a processor and a memory. The shared processor or chip can execute a program-related code to implement a corresponding function.

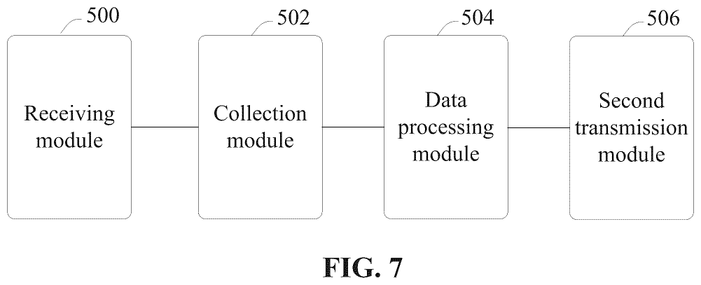

FIG. 7 is a schematic diagram of another in-orbit real-time task processing device based on multi-satellite collaborative computing that corresponds to FIG. 5 according to the present disclosure. The device is applied to a target satellite of an in-orbit real-time task processing system based on multi-satellite collaborative computing, the system includes a ground center and a plurality of satellites, and the target satellite is determined by the ground center from the satellites based on task location information in instruction text of a user and orbital trajectories of the satellites. As shown in FIG. 7, the device includes:
a receiving module 500 configured to receive the instruction text and the task location information that are sent by the ground center;
a collection module 502 configured to collect a remote-sensing image based on the task location information;
a data processing module 504 configured to input the remote-sensing image and the instruction text into a pre-configured remote-sensing large model, determine a data processing task corresponding to the instruction text, and perform data processing on the remote-sensing image based on the data processing task to obtain result data output by the remote-sensing large model; and
a second transmission module 506 configured to send the result data to the ground center.

Optionally, the data processing module 504 is specifically configured to input the remote-sensing image and the instruction text into the pre-configured remote-sensing large model, perform semantic analysis on the instruction text through the remote-sensing large model to determine an observation target corresponding to the instruction text, determine the data processing task corresponding to the instruction text as a target extraction task for the observation target, perform target extraction on the remote-sensing image based on the observation target to obtain a target image output by the remote-sensing large model, and determine the result data based on the target image.

Optionally, the data processing module 504 is specifically configured to determine the observation target in the remote-sensing image through the remote-sensing large model, and determine the target image based on a corresponding image region of the observation target in the remote-sensing image.

Optionally, the data processing module 504 is specifically configured to perform image analysis on the observation target in the target image by using the remote-sensing large model based on the instruction text, generate result text corresponding to the instruction text, and determine the result data based on the result text.

Optionally, each of the satellites is equipped with a satellite-borne router, and the second transmission module 506 is specifically configured to: receive an inter-satellite link establishment instruction sent by the ground center, where the inter-satellite link establishment instruction is that the ground center determines, from the satellites based on the orbital trajectories of the satellites and the task location information, a satellite that communicates with the ground center as a return satellite and a satellite between the target satellite and the return satellite as a transfer satellite; and determine an inter-satellite communication path among the target satellite, the transit satellite, and the return satellite.

Optionally, the second transmission module 506 is specifically configured to send the result data to the transfer satellite through the inter-satellite communication path, such that the transfer satellite sends the result data to the return satellite through the inter-satellite communication path, and then the return satellite transmits the result data to the ground center.

Optionally, the data processing module 504 is specifically configured to determine a computing board for performing the data processing task as a target board, monitor performance parameters of the computing boards, and re-determine a target board from various computing boards excluding the target board when determining, based on a performance parameter of the target board, that performance of the target board is abnormal.

In this embodiment of the present disclosure, the receiving module 500, the collection module 502, the data processing module 504, and the second transmission module 506 each may be one or more processors or chips that each have a communication interface, can realize a communication protocol, and may further include a memory, a related interface and system transmission bus, and the like if necessary. The processor or chip executes program-related code to realize a corresponding function. In an alternative solution, the receiving module 500, the collection module 502, the data processing module 504, and the second transmission module 506 may share an integrated chip or share devices such as a processor and a memory. The shared processor or chip can execute a program-related code to implement a corresponding function.

It should also be noted that the term “comprise”, “include”, or any other variant thereof is intended to encompass a non-exclusive inclusion, such that a process, method, product, or device that includes a series of elements includes not only those elements, but also other elements not explicitly listed, or elements that are inherent to such a process, method, product, or device. Without more restrictions, an element defined by the phrase “including a . . . ” does not exclude the presence of another same element in a process, method, product, or device that includes the element.

The embodiments in the present disclosure are described in a progressive manner. For same or similar parts between the embodiments, reference can be made to each other. Each embodiment focuses on a difference from other embodiments. For a system embodiment, since it is basically similar to the method embodiment, the description is relatively simple, and reference can be made to the description of the method embodiment.

The above are merely embodiments of the present disclosure, and are not intended to limit the present disclosure. Various changes and modifications can be made to the present disclosure by those skilled in the art. Any modifications, equivalent replacements, and improvements made within the spirit and principle of the present disclosure should be included within the protection scope of the claims of the present disclosure.

1. An in-orbit real-time task processing system based on multi-satellite collaborative computing, wherein the in-orbit real-time task processing system comprises a ground center and a plurality of satellites;
the ground center responds to instruction text of a user and determines task location information in the instruction text; determines a target satellite from the satellites based on orbital trajectories of the satellites and the task location information; and sends the instruction text and the task location information to the target satellite; and
the target satellite collects a remote-sensing image based on the task location information; inputs the remote-sensing image and the instruction text into a pre-configured remote-sensing large model, determines a data processing task corresponding to the instruction text, and performs data processing on the remote-sensing image based on the data processing task to obtain result data output by the remote-sensing large model; and sends the result data to the ground center.

2. The in-orbit real-time task processing system according to claim 1, wherein the target satellite inputs the remote-sensing image and the instruction text into the pre-configured remote-sensing large model, and performs semantic analysis on the instruction text through the remote-sensing large model to determine an observation target corresponding to the instruction text; determines the data processing task corresponding to the instruction text as a target extraction task for the observation target; and performs target extraction on the remote-sensing image based on the observation target to obtain a target image output by the remote-sensing large model; and
determines the result data based on the target image.

3. The in-orbit real-time task processing system according to claim 2, wherein the observation target in the remote-sensing image is determined through the remote-sensing large model, and the target image is determined based on a corresponding image region of the observation target in the remote-sensing image.

4. The in-orbit real-time task processing system according to claim 2, wherein the target satellite performs image analysis on the observation target in the target image by using the remote-sensing large model based on the instruction text, and generates result text corresponding to the instruction text; and
determines the result data based on the result text.

5. The in-orbit real-time task processing system according to claim 1, wherein each of the satellites is equipped with a satellite-borne router; and
the ground center determines, from the satellites based on the orbital trajectories of the satellites and the task location information, a satellite that communicates with the ground center as a return satellite and a satellite between the target satellite and the return satellite as a transfer satellite; and determines an inter-satellite communication path among the target satellite, the transfer satellite, and the return satellite.

6. The in-orbit real-time task processing system according to claim 5, wherein the ground center uploads the instruction text and the task location information to the return satellite;
the return satellite sends the instruction text and the task location information to the transfer satellite through the inter-satellite communication path; and
the transfer satellite sends the instruction text and the task location information to the target satellite through the inter-satellite communication path.

7. The in-orbit real-time task processing system according to claim 6, wherein the target satellite sends the result data to the transfer satellite through the inter-satellite communication path;
the transfer satellite sends the result data to the return satellite through the inter-satellite communication path; and
the return satellite transmits the result data to the ground center.

8. The in-orbit real-time task processing system according claim 1, wherein the target satellite comprises a plurality of computing boards; and
the target satellite determines a computing board for performing the data processing task as a target board; monitors performance parameters of the computing boards; and re-determines a target board from various computing boards excluding the target board when determining, based on a performance parameter of the target board, that performance of the target board is abnormal.

9. An in-orbit real-time task processing method based on multi-satellite collaborative computing, wherein the in-orbit real-time task processing method is applied to a ground center of an in-orbit real-time task processing system based on multi-satellite collaborative computing, the in-orbit real-time task processing system comprises the ground center and a plurality of satellites, and the in-orbit real-time task processing method comprises:
responding to instruction text of a user, and determining task location information in the instruction text;
determining a target satellite from the satellites based on orbital trajectories of the satellites and the task location information; and
sending the instruction text and the task location information to the target satellite, whereby the target satellite collects a remote-sensing image based on the task location information, inputs the remote-sensing image and the instruction text into a pre-configured remote-sensing large model, determines a data processing task corresponding to the instruction text, performs data processing on the remote-sensing image based on the data processing task to obtain result data output by the remote-sensing large model, and sends the result data to the ground center.

10. An in-orbit real-time task processing method based on multi-satellite collaborative computing, wherein the in-orbit real-time task processing method is applied to a target satellite of an in-orbit real-time task processing system based on multi-satellite collaborative computing, the in-orbit real-time task processing system comprises a ground center and a plurality of satellites, the target satellite is determined by the ground center from the satellites based on task location information in instruction text of a user and orbital trajectories of the satellites, and the in-orbit real-time task processing method comprises:
receiving the instruction text and the task location information that are sent by the ground center;
collecting a remote-sensing image based on the task location information;
inputting the remote-sensing image and the instruction text into a pre-configured remote-sensing large model, determining a data processing task corresponding to the instruction text, and performing data processing on the remote-sensing image based on the data processing task to obtain result data output by the remote-sensing large model; and
sending the result data to the ground center.

11. An in-orbit real-time task processing device based on multi-satellite collaborative computing, wherein the in-orbit real-time task processing device is applied to a ground center of an in-orbit real-time task processing system based on multi-satellite collaborative computing, the in-orbit real-time task processing system comprises the ground center and a plurality of satellites, and the in-orbit real-time task processing device comprises:
a task location determining module configured to respond to instruction text of a user, and determine task location information in the instruction text;
a target satellite determining module configured to determine a target satellite from the satellites based on orbital trajectories of the satellites and the task location information; and
a first transmission module configured to send the instruction text and the task location information to the target satellite, whereby the target satellite collects a remote-sensing image based on the task location information, inputs the remote-sensing image and the instruction text into a pre-configured remote-sensing large model, determines a data processing task corresponding to the instruction text, performs data processing on the remote-sensing image based on the data processing task to obtain result data output by the remote-sensing large model, and sends the result data to the ground center.

12. An in-orbit real-time task processing device based on multi-satellite collaborative computing, wherein the in-orbit real-time task processing device is applied to a target satellite of an in-orbit real-time task processing system based on multi-satellite collaborative computing, the in-orbit real-time task processing system comprises a ground center and a plurality of satellites, the target satellite is determined by the ground center from the satellites based on task location information in instruction text of a user and orbital trajectories of the satellites, and the in-orbit real-time task processing device comprises:
a receiving module configured to receive the instruction text and the task location information that are sent by the ground center;
a collection module configured to collect a remote-sensing image based on the task location information;
a data processing module configured to input the remote-sensing image and the instruction text into a pre-configured remote-sensing large model, determine a data processing task corresponding to the instruction text, and perform data processing on the remote-sensing image based on the data processing task to obtain result data output by the remote-sensing large model; and
a second transmission module configured to send the result data to the ground center.
